(19) United States
(12) Patent Application Publication
(10) Pub. No.: US 2010/0241590 A1
(43) Pub. Date: Sep. 23, 2010

(54) METHOD OF CREATING A FINANCIAL INSTRUMENT

(75) Inventor: Howard Bryce Moore, Wellington (NZ)

Correspondence Address: Hovey Williams LLP, 10801 Mastin Blvd., Suite 1000, Overland Park, KS, 66210, US

(73) Assignee: AUCROP LIMITED, Wellington (NZ)

(21) Appl. No.: 12/740,946

(22) PCT Filed: Nov. 4, 2008
(86) PCT No.: PCT/NZ08/00296

§ 371 Date: Apr. 30, 2010

(30) Foreign Application Priority Data
Nov. 7, 2007 (NZ) 563260

(51) Int. Cl. G06Q 40/00; G06Q 50/00

(52) U.S. Cl. 705/36 R; 705/37

(57) ABSTRACT

The present invention relates to a central processing station for creating a financial instrument, wherein the central processing station is configured to operate in accordance with the following steps: selecting a biological asset; and assigning one or more biological growth models to that biological asset; and determining a current value for the biological asset; and issuing, based upon said current value one or more redeemable certificates associated with the biological asset; and determining at any point in the future new current values of the certificates using the growth model.

### FIELD OF INVENTION

The present invention relates to a method of creating a financial instrument.

### BACKGROUND ART

Financial instruments take many forms. However, each financial instrument represents a legal agreement involving some sort of monetary value. Financial instruments may generally be classified as equity based, representing ownership of an asset, or debt based, representing a loan made by an investor to the owner of the asset.

Derivatives are a class of equity based instruments. Wikipedia describes them as “financial instruments whose value changes in response to the changes in underlying variables. The main types of derivatives are futures, forwards, options, and swaps. The main use of derivatives is to reduce risk for one party . . . . Derivatives can be based on different types of assets such as commodities, equities (stocks), bonds, interest rates, exchange rates, or indexes (such as a stock market index . . . ).”

The financial instrument that is the object of this invention may be used to reduce risk within an investment portfolio.

Diversification of an investment portfolio allows an investor to reduce the overall risk to which the investment portfolio is exposed. It is often advantageous to include within the portfolio investments whose values rise and fall differently from or even counter-cyclically to other investments. Portfolio management theory suggests that an investor should seek to minimise the standard deviation of return of his overall portfolio—that is, the volatility or fluctuation of its returns over time.

One key determinant of a given portfolio's degree of volatility is the relationship of the returns of each portfolio asset to every other portfolio asset owned by the investor. This relationship can be quantified by the correlation coefficient statistic, which provides a measure of the degree to which two variables move together. A correlation coefficient can vary between +1.0 and −1.0, which extremes respectively mean perfect correspondence of movement of two variables in the same direction, and perfect correspondence of movement of two variables in opposite directions.

In order to reduce volatility of returns portfolio investors therefore tend to include asset classes whose returns are negatively correlated. For example, pension funds invest in timberlands as it has been observed that the value of timberlands is generally negatively correlated to the values of the major financial asset classes of shares, treasury bills, and corporate or government bonds. The inclusion of timberlands in such an investment portfolio dampens fluctuations in the value of the overall portfolio.

When fluctuations in the value of an overall portfolio have been reduced the effect is to extend the “efficient frontier” of the portfolio. That is, for any given tolerance of risk, an investor with a stable portfolio is generally more willing to invest in higher returning (and more risky) assets than an investor with a volatile portfolio. The addition of assets whose returns are negatively correlated can therefore improve the average returns of the whole portfolio. Higher average returns create an important competitive advantage for portfolio investment managers, such as pension fund managers.

As this asset class behaviour has become better understood fund managers have increasingly purchased timberlands to add to their investment portfolios. In the USA investment by fund managers in timberlands rose from US$9 billion to US$29 billion over the ten years from 1997. With limited areas of timberland available for purchase in the USA, portfolio investors are also seeking timberland investments in foreign countries.

The negative correlation between the returns of timberland as an investment and those of the major financial asset classes is believed to be due in part to the increase in timber volume over time arising from natural biological growth, the movement of that volume into more valuable grades as it ages and grows larger piece sizes, and the price movements of those harvestable grades and sizes. Of course biological growth is totally independent of market conditions and these factors also provide an investor in timberland with a degree of protection against inflation.

Overall, the general characteristics of timberlands are positive and some qualities include the following:
Commercial forests increase in timber value through biological growth, although it is recognised that pathogens, pests, fire and storm damage can moderate this rate of natural increment.
Timberlands use rural land for which there may be some value appreciation over time. That value may track commercial property values in the region.
Timberlands provide wildlife habitats, maintain biodiversity and can also provide recreational and hunting benefits.
The landscape provided by timberlands can provide aesthetic benefits.
Timberlands provide soil conservation as well as water quality. This can maintain the land use values of adjacent downstream communities.
As forests gain mass, they sequester atmospheric carbon.

However, there are problems with investing in timberlands.
There are a limited number of commercial forests for which there are investment opportunities available.
Generally, the minimum investment required in timberlands is high. Correspondingly, the investments are dominated by large institutional investors and high net worth individuals.
Although alternate investments can be made in the stocks and shares of timber producers, this does not give direct access to commodity prices and exposes investors to liabilities associated with processing assets and business management.
Because of the low liquidity and long maturity of forests, timberland investments can be difficult to buy and trade.

It can be seen that there would be advantages in marketing a financial instrument that gave the investor the benefits of investing in biological assets such as timberlands, but with a reduced number of associated problems.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### DISCLOSURE OF INVENTION

According to one aspect of the present invention, there is provided a method of creating a financial instrument,

the method characterised by the steps of:
a) selecting a biological asset; and
b) assigning one or more biological growth models to that biological asset; and
c) determining a current value for the biological asset; and
d) issuing, based upon said current value, one or more redeemable certificates associated with the biological asset; and
e) determining at any point in the future new current values of the certificates using the growth model.

According to another aspect of the present invention, there is provided a method of creating a financial instrument,

the method characterised by the steps of:
a) selecting a virtual biological asset whose key characteristics are based upon those that would be present in an equivalent real biological asset; and
b) assigning one or more biological growth models that would apply to the equivalent real biological asset to the virtual biological asset; and
c) determining a current value for the virtual biological asset using the growth model; and
d) issuing, based upon said current value, one or more redeemable certificates associated with the said virtual biological asset;
e) determining at any point in the future new current values of said certificates using the growth model.

It should be appreciated that the term certificate should be understood to mean any document, whether in hard or soft copy, that provides proof of the investment made in the biological asset.

Reference throughout the specification shall be made to the biological asset (whether real or virtual) as being a forest or timberland. However, as discussed immediately below, the present invention can be applied to any type of biological asset.

As examples of other applications, the financial instrument may be based on virtual biological assets or real biological assets with a shorter lifespan than that of timberlands. It is preferred that in these other applications the instrument is based on assets that have biological growth over a period of years rather than of months but this preference does not limit the application of the instrument to those longer-lived assets. A requirement is that the particular asset that underlies the behaviour of the instrument and is used as the selected real biological asset or the equivalent real biological asset has well established growth models associated therewith and that its biological growth can be valued.

Growth models are required when calculating the value of the financial instrument at any time as it increases in virtual biological age. An increase in the value of a real biological asset occurs through natural growth, which results in accretion of mass and a change in the quality of that mass with age; and through changing market values from time to time for the harvest of the produce of that biological asset. A virtual biological asset can be valued in a similar way as its equivalent real counterpart.

The financial instrument may for example be based upon crops such as fruit, nuts, vegetables, maize, soy beans or sugar cane. The instrument may be sold for a virtual freshly planted or immature crop and redeemed later at the point of harvest when the virtual crop was mature. The sale value of the financial instrument on being issued by a trading bank would be associated with the real price of buying a specific area of immature or freshly planted crop from a farmer who had planted it but who wanted to take a fixed immediate return rather than the crop risk and a return on harvest. The price charged by the farmer, or the equivalent price if no real transaction was available, would logically represent the net present value of the crop on harvest allowing for forecast costs and revenues including the ground rent that the farmer would charge over the period for using his land to grow and harvest the crop.

The trading bank's redemption value of the financial instrument could be the quantity of the virtual crop as determined by the growth model, priced at the prevailing market value of an equivalent real crop, less the industry standard costs of growing, harvesting and marketing an equivalent real crop of the same variety in the same region grown under the same farming regime. The growth model which determined the quantity of the crop could factor in the variety of the crop, the region in which it was grown, the crop risks, how the crop was managed and the age of the crop.

Similarly, the financial instrument may be based upon the growth of domestic or farm animals, which are bred and grown to a point in their lives when they produce income. Again, the method would use the appropriate biological growth models of those animals. The financial instrument may for example be sold for virtual weaned heifers and redeemed after a fixed period when those heifers became milk cows. The trading bank's sale value on issuing the instrument could be the real price of buying a herd of live weaned heifers of a specific breed and known condition, born and raised in a particular region. Its redemption value could be the price of a buying a herd of milk cows of the same breed and similar condition, raised in the same region and sold at their prevailing market value; less the industry standard cost of raising the cows from heifers and marketing them. The quantity of finished cows and their average weight and condition would be determined from the growth model, which would factor in the region, the expected mortality rate, the management regime in terms of care and feeding and the animals' age.

The financial instrument to be described herein derives its change in value by reference to the physical growth of a specified real biological asset and the market prices from time to time of the harvestable produce from that real biological asset. As these characteristics are present in real timberlands the instrument behaves in some ways like real timberlands in that changes in the value of the instrument are negatively or weakly correlated with the major financial asset classes.

The growth model can take into account a number of considerations. Firstly, a basic growth model can take into account the mere likely accumulation of mass of the biological asset over a particular time. The future mass could be multiplied by the current value per unit mass to give the future value of the asset.

The growth model may take into account typical weather conditions in a particular region where the biological asset grows, a risk factor for pests, fire and weather damage and possibly even appropriate management techniques.

However, it is envisaged that a calculation of the future value of the asset will not only take into account the mass increase predicted by the biological growth model, but also market forces. For example, the future value may take into account the cost of managing the biological asset and the market prices currently prevailing for the harvestable produce of the biological asset as well as the expected increment in the harvestable produce through biological growth.

It should be appreciated that for the implementation of the present invention to be successful, considerable credibility is required in the valuation methodology. It is therefore envisaged that the suppliers of the growth model (say when the asset is timberlands) would be scientists having access to considerable amounts of historical measurements associated with the forest.

As this model could be used with market prices, it is also envisaged that the services of experts in the area of market price surveys could be used to supply information to be used in conjunction with the growth model to determine future values.

In preferred embodiments it is envisaged that the certificates will have a redemption date or a calendar period during which they can be presented to the issuer for redemption. The amount given in redemption is intended to be the value as calculated with regard to the previously discussed methods.

It should be appreciated that due to the complexities of the growth models and value calculation methods that there will be provided computer executable instructions by which the method of the present invention can be implemented.

It may be that there is a credible body that is in a position to control access to these computer executable instructions and is independent of the party issuing the certificates and the party receiving the certificates. Thus, this independent party could provide to a certificate holder and issuer alike independently derived values of the certificate based on the growth model and market forces.

Therefore it can be seen in one embodiment of the present invention there may be provided a centralised processor that upon request can provide to enquirers the value of the certificate at a particular time. This is naturally easily facilitated if all the enquirer had to do was to provide a unique identifier on the certificate to the central processor.

Disclosed is a financial instrument that is based upon ownership of a real biological asset such as a crop, a herd of animals or a timberland. Because the instrument is based upon a real asset, it is constrained by the age, size, location and quality of that asset. However because the instrument may be replicated many times in identical form, it is not constrained by the availability of real assets except in as much as one real biological asset has been selected as the base of the instrument. The owner of the selected real biological asset may or may not be the issuer or the purchaser of the said financial instrument or associated in any way with the owner or purchaser.

Although the instrument is based on ownership of a selected real biological asset, the issue, or purchase of the instrument does not confer title to that biological asset or ownership of anything other than the instrument itself. Accordingly it might be traded more easily than the underlying real biological asset, having much greater flexibility, wider appeal and hence greater liquidity as an investment than ownership of the underlying real asset.

### BRIEF DESCRIPTION OF THE DRAWINGS

One or more embodiments of the present invention will now be described with reference to the drawings, in which:

FIG. 1 shows a schematic flow diagram of a method of creating a financial instrument; and

FIG. 2 shows a schematic block diagram of a system upon which the arrangements described can be practiced; and

FIG. 3 shows a schematic block diagram of the commercial relationships that could apply in creating, issuing, trading and redeeming the financial instrument; and

FIG. 4 shows a schematic block diagram of the commercial relationships that could apply in one particular use of the financial instrument; and

FIG. 5 shows a schematic block diagram of the relationships that could apply in the process of creating a typical biological asset certificate based upon ownership of a real biological asset such as a timberland; and

FIG. 6 shows a schematic block diagram of the relationships that could apply in the process of creating a typical biological asset certificate based upon a virtual biological asset such as a virtual timberland.

### DESCRIPTION OF THE INVENTION

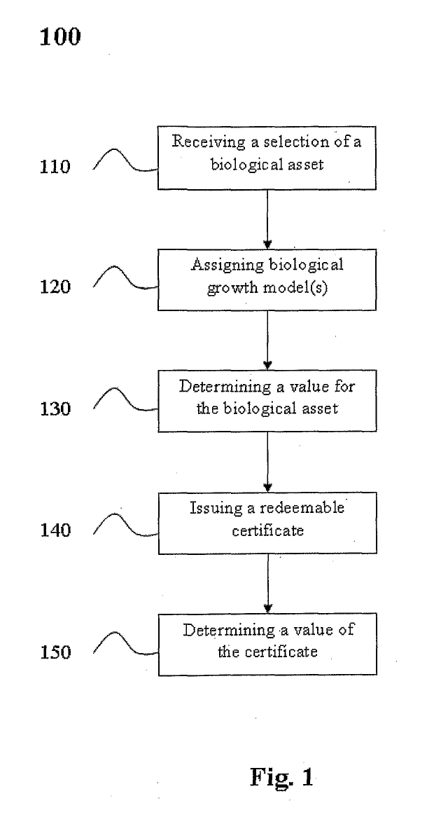

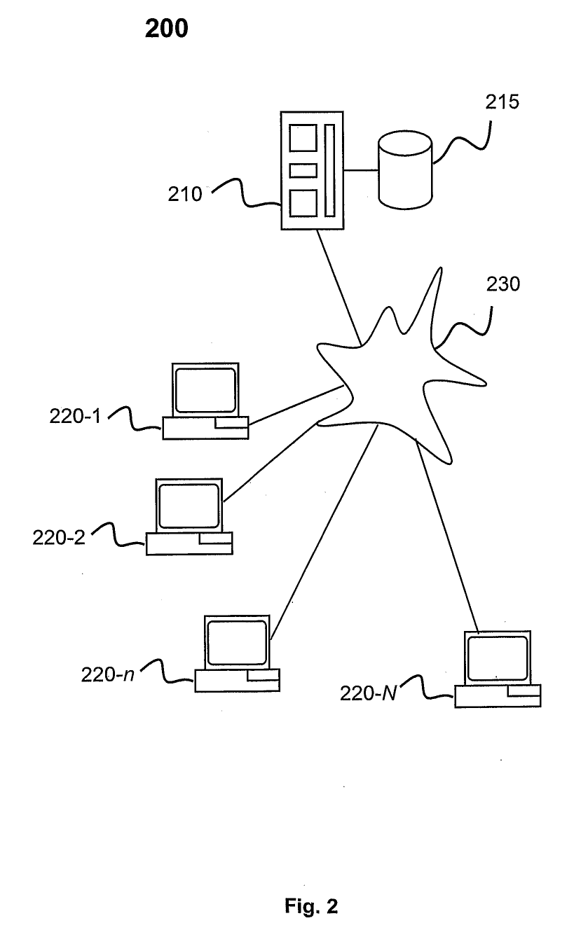

FIG. 1 shows a schematic flow diagram of a method 100 of creating a financial instrument. Method 100 may be implemented using a computer system, such as computer system 200 shown in FIG. 2, where the steps of method 100 are implemented as software, such as one or more application programmes executing within the computer system 200. The computer system 200 includes a number of work stations 220-1 to 220-N connected through a network 230 to a server 210. The server 210 has associated therewith a database 215. The network 230 is preferably the Internet.

Referring again to FIG. 1, the method 100 starts in step 110 where the computer system 200 receives a selection of a real biological asset. In the present example the real biological asset is a timberland. An operator uses one of the work stations 220-n to enter the tree species of the selected timberland, the location of the timberland, the mix of area by age class and the forest management regime of the timberland from data sourced from the owner of the real timberland. The operator specifies this information consistent in form and content with one or more growth models that have either been derived from and apply to the selected real timberland or derived from and apply to an equivalent real timberland consisting of the same tree species grown in the same region under the same forest management regime as the selected real timberland.

The method of 100 then proceeds to step 120 where one or more biological growth models are assigned to the real biological asset. In the present example, a forest growth model or growth models are chosen and assigned to the selected timberland consistent with the information entered by the operator. Each biological growth model estimates growth and yield modelling of a specific tree species over the expected life of an even-aged stand of those trees. As each growth model is also related to a region it also contains or may have assigned to it a statistically correct level of annual damage to timberland in that region through natural causes, such as disease, pests, fire and storm damage. This allows the growth model to be used when estimating the volume by grade of recoverable timber, fuel wood and chip wood that can be harvested from a particular area of the timberland at any age. As is described below, when those estimates are combined with external factors such as forest management costs, harvesting and marketing costs and wood prices, those estimates are used by the system 100 to determine the market value of the standing forest on the selected timberland at any chosen point in its growth cycle.

Growth models for timberlands are used when estimating the volumes by grade of recoverable timber, fuel wood and chip wood that the standing forests in the timberlands contain per unit of area, at any point in their growth cycle. These harvestable volumes in the standing forests are influenced over time by tree growth rates; tree form (taper, final height and branching characteristics), wood quality (density, age and stiffness) and the number of harvestable trees per hectare. Growth rates are in turn affected by the species and genetic strain of the trees. As different genetic strains within a species grow at different rates and have different forms and wood qualities, for some tree species, if the genetic strain or seed source is known the estimates of recoverable volumes can be estimated more accurately. The volumes and grades of recoverable timber, fuel wood and chip wood are also influenced by the location of the timberland, which determines the latitude, altitude, growing conditions and typical soil types.

Through the database 215 the system 100 is able to select the growth model or growth models appropriate to the information entered by the operator at the work station when he specified for the selected timberland the tree species, the location, the mix of area by age class and the forest management regime. The management regime applied to a stand of trees prescribes the work done to the trees to help them grow into a commercial, productive crop. Such work includes planting the trees at some initial stems per hectare, thinning them and pruning them. Thinning and pruning affect growth rates by altering competition and canopy. Thinning reduces competition and allows each tree a greater canopy improving its growth rate. Pruning improves log quality and may improve tree value but initially reduces canopy and growth rate.

The mix of area by age class specifies the age of the trees, and the area of forest occupied by each age class. Tree growth rate varies with age. The growth of a tree typically starts out slowly, accelerates when the tree is young and vigorous, and then slows down again as it reaches maturity.

In step 130 that follows a valuation model is used to calculate the value of the real biological asset specified by the operator at the time he enters the information into the work station.

In this example the information entered is the tree species of the selected timberland, the location of the timberland, the mix of area by age class and the forest management regime of the timberland. From the information entered a growth model or models is assigned to the selected timberland.

The estimate derived from the growth model of the volumes by grade of recoverable timber, fuel wood and chip wood that can be harvested from a particular area of the selected timberland at a specified age is combined with a forest valuation model to calculate the current value of the standing forests in the selected timberland. The forest valuation model acknowledges external factors affecting the timberland such as access, distance from markets, the current market prices by grade for timber, fuel wood and chip wood, forest management costs and harvesting and marketing costs.

Forest valuation models use discounted cash flow analysis to determine the net present value of a timberland, assuming a stream of future costs and revenues from the present day to the point of harvesting and marketing. Generally the only future revenues from the timberland will be those that arise on harvest. These can be estimated from the area of each age class of trees in the timberland; current market prices by grade for timber, fuel wood and chip wood; and the forest growth models that indicate recoverable volumes per unit of area at the age the trees are harvested. The stream of future costs in a timberland may include: tending operations, rates, ground rent, insurance, fire protection, pest control, repairs and maintenance of fences, roads and culverts, and administration. Depending on the age of the timberland, tending operations may already have finished. When the trees are harvested, costs may include a pre-harvest inventory to assess more accurately the recoverable volumes; widening and strengthening of roads to bring them up to harvest standard; and harvesting and marketing expenses.

The valuation model calculates the net present value of the standing forests in the selected real timberland. It does this by taking the streams of future costs and revenues described above as those streams apply to the selected timberland, from the date of valuation to the date of the proposed harvest, and applying discounted cash flow analysis to those streams of future costs and revenues using an industry-acceptable discount rate. All of the necessary current costs, prices and discount rates applying to the selected timberland and required by the valuation model are available either from the owner of the selected timberland, or from industry bodies who may refer to industry average costs, prices and discount rates applying to an equivalent real timberland, or from both. Discount rates vary from country to country but in New Zealand a typical forestry discount rate is 8% pa real, post tax.

The calculated net present value from the valuation model forms the basis for pricing the certificates associated with the real biological asset.

In step 140 that follows one or more redeemable certificates associated with the real biological asset are issued by the computer system 200. More particularly, a biological asset certificate is printed by the server 210, or one of the work stations 220-n, and issued to the purchaser of the financial instrument in exchange for a consideration that is based upon the calculation undertaken in step 130.

Each redeemable biological asset certificate so issued is identified with a unique identification number, and is recorded with its date of issue in the database 215 together with its redemption date or the calendar period at any time during which it may be presented back to the issuer for redemption; the contact details of the owner of the certificate; a description of the biological asset that the certificate represents, and the biological growth model(s) and valuation model(s) associated with that biological asset.

At any date after issue the value of the certificate may be determined in step 150 by the system 100. As in step 130 the determination of the value is typically initiated by an operator from one of the work stations 220-n.

The value of the certificate may be determined to facilitate a trade in which the current owner of the certificate offers to sell it to another investor for a consideration based on the value so determined. Should a certificate be traded by an owner at any time prior to its redemption the change of ownership is recorded against the certificate so traded in the database 215. The database 215 acts as a registry of all issued certificates and their current owners.

Each certificate is associated with a redemption date or a calendar period at any time during which it may be presented back to the issuer for redemption. When the certificate is presented for redemption on such a valid redemption date the issuer may redeem it at its value on that date as determined in this step 150.

In step 150 the value of the certificate is again determined using a volume estimate derived from the biological growth models, and the valuation model. In the present example, the one or more biological growth models associated with the selected real timberland are used to calculate the increase in yield that has occurred in the timberland over the time that has elapsed since the certificate was first issued. As in step 130 the valuation model is also updated with current forestry costs, wood prices and discount rates. As described above, the forest valuation model makes provisions for costs relevant to the selected real timberland or to an equivalent real timberland including the costs of rates, insurance, fire protection, pest control, repairs and maintenance, administration, pre-harvest inventory and harvesting and marketing. All of the necessary current costs, prices and discount rates applying to the selected timberland and required by the valuation model are available either from the owner of the selected timberland, or from industry bodies who may refer to industry average costs, prices and discount rates applying to an equivalent real timberland, or from both.

Step 150 is different in part from step 130 because in step 150, in addition to the estimates of future costs the value of each certificate is also affected by past costs, which are the costs that the owner of the selected real biological asset has incurred over the period since the certificate was issued. Past costs in the same categories as the future costs used in step 130 are accumulated and compounded forward at the rates of interest that applied and for the periods that applied from the date of purchase of the certificate to the date of its present valuation, and then deducted from the calculated present value of the certificate so as to fairly reflect the holding costs of the real biological asset since the certificate was issued. The applicable historic costs and rates of interest are provided either from the owner of the selected timberland, or from industry bodies who may refer to industry average costs, prices and interest rates applying to an equivalent real timberland, or from both.

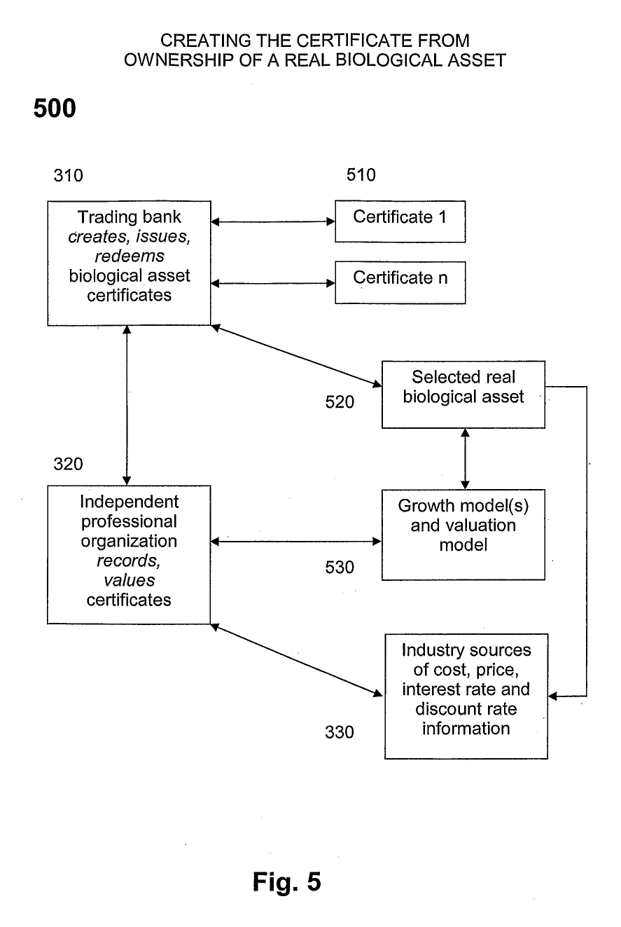

FIG. 5 shows a schematic block diagram of the relationships that could apply in the process of creating a typical biological asset certificate, based upon ownership of a real biological asset such as a timberland.

To commence the process 500 a trading bank 310 makes a selection of a real biological asset 520. Using one of the work stations 220-n of FIG. 2 it advises that selection over network 230 to an independent professional organisation 320.

The independent professional organisation 320 assigns one or more appropriate growth models 530 to the selected real biological asset 520 and determines the value of the real biological asset with reference to the growth models and information obtained on costs, prices, interest rates and discount rates from industry sources 330. The organisation then advises the trading bank 310 of the value, using network 230 of FIG. 2.

On receipt of the value so determined the trading bank 310 creates one or more biological asset certificates 510 relating to the real biological asset 520 and priced in relation to the value advised by organisation 320.

Carbon sequestration may also be taken into account when determining the value of a certificate based on a real timberland. The amount of carbon stored in a forest is directly related to the physical mass of the forest. Carbon sequestration may therefore be measured by applying known conversion factors to the recoverable volumes by tree species estimated by the forest growth models. The stored carbon will have a value related to the market value of carbon credits at the time. Accordingly stored carbon can be regarded and valued as part of the family of wood produce that includes timber, fuel wood and chip wood. The major difference is that carbon values will only be realised if the forest is left standing while timber, fuel wood and chip wood values will only be realised if the forest is harvested. Hence stored carbon values will also be dependent upon the market's confidence that the forest will remain standing into the future. Independent parties may be contracted to measure the biological mass and hence the carbon content of any given timberland. Industry bodies can provide the known conversion factors and current market values of carbon credits, which can be applied to determine the value of the carbon content.

An alternate embodiment of the present invention is a financial instrument that is based upon ownership of a virtual biological asset such as a virtual timberland, whose value performs like that of a derivative based on the ownership of a real biological asset, like a real timberland. Because the disclosed financial instrument is based on a virtual asset, that asset could be of any chosen age, size, location and quality. However the description of the virtual asset is selected so that it corresponds in many respects to that of a real biological asset for which growth models, costs and market prices are known and available. The underlying real biological asset that is chosen to provide the descriptive parameters might be called the “equivalent” real biological asset.

Provided the necessary factual information is available that describes or has been derived from or applies to the equivalent real biological asset, and that information is sufficient to adequately define the virtual biological asset, the said virtual asset can be created whether or not the equivalent real biological asset physically exists at the time. If such an equivalent real biological asset does exist it need not be owned by or in any other way associated with the issuer or the purchaser of the said financial instrument.

Many virtual biological assets could be created from an equivalent real biological asset using the same set of descriptive parameters with or without variations in non-critical parameters such as size or age. The number of virtual assets so created would not be constrained by the age, size, location and quality of any equivalent real biological asset.

As the virtual biological asset is neither limited in numbers nor reliant on the existence nor the ownership of the equivalent real biological asset, the financial instrument might be traded more easily than the equivalent real biological asset, having much greater flexibility, wider appeal and hence greater liquidity as an investment.

As noted earlier, FIG. 1 shows a schematic flow diagram of a method 100 of creating a financial instrument. Method 100 may be implemented using a computer system, such as computer system 200 shown in FIG. 2, where the steps of method 100 are implemented as software, such as one or more application programmes executing within the computer system 200. The computer system 200 includes a number of work stations 220-1 to 220-N connected through a network 230 to a server 210. The server 210 has associated therewith a database 215. The network 230 is preferably the Internet.

Referring again to FIG. 1, the method 100 starts in step 110 where the computer system 200 receives a selection of a virtual biological asset. In the present example the virtual biological asset is a virtual timberland. An operator uses one of the work stations 220-n to enter the tree species of the virtual timberland, the location of the virtual timberland, the mix of area by age class and the forest management regime of the virtual timberland, to the same level of detail as if it were an equivalent real timberland. The operator specifies this information consistent in form and content with one or more growth models that have been derived from and apply to an equivalent real timberland consisting of the same tree species grown in the same region under the same forest management regime as the virtual timberland described.

The method of 100 then proceeds to step 120 where one or more biological growth models are assigned to the virtual biological asset. In the present example, a forest growth model or growth models are chosen and assigned to the virtual timberland consistent with the information entered by the operator. Each biological growth model estimates growth and yield modelling of a specific tree species over the expected life of an even-aged stand of those trees. As each growth model is also related to a region it also contains or may have assigned to it a statistically correct level of annual damage to timberland in that region through natural causes, such as disease, pests, fire and storm damage. This allows the growth model to be used when estimating the volume by grade of recoverable timber, fuel wood and chip wood that can be harvested from a particular area of the timberland at any age. As is described below, when those estimates are combined with external factors such as forest management costs, harvesting and marketing costs and wood prices, those estimates are used by the system 100 to determine the notional market value of the standing forest on the virtual timberland at any chosen point in its growth cycle.

Through the database 215 the system 100 is able to select the growth model or growth models appropriate to the information entered by the operator at the work station when he specified for the virtual timberland the tree species, the location, the mix of area by age class and the forest management regime.

In step 130 that follows a valuation model is used to calculate the value of the virtual biological asset specified by the operator at the time he enters the information into the work station.

In this example the information entered is the tree species of the virtual timberland, the location of the virtual timberland, the mix of area by age class and the forest management regime of the virtual timberland. From the information entered a growth model or models relevant to an equivalent real timberland is assigned to the virtual timberland.

The estimate derived from the growth model of the notional volumes by grade of recoverable timber, fuel wood and chip wood that can be harvested from a particular area of the virtual timberland at a specified age is combined with a forest valuation model to calculate the current notional value of the standing forests in the virtual timberland. The forest valuation model acknowledges external factors affecting an equivalent real timberland such as access, distance from markets, the current market prices by grade for timber, fuel wood and chip wood, forest management costs and harvesting and marketing costs.

The valuation model calculates the notional net present value of the virtual timberland. It does this by taking the streams of future costs and revenues that would apply to an equivalent real timberland of the same species operating on the same specified management regime in the same region and containing the same mix of areas by age class, from the date of valuation to the date of the proposed harvest, and applying discounted cash flow analysis to those streams of future costs and revenues using an industry-acceptable discount rate. All of the necessary current costs, prices and discount rates applying to the equivalent real timberland and required by the valuation model are available through industry bodies. As road repair and maintenance costs are generally site-specific an average road repair and maintenance cost for an equivalent real timberland is preferably applied in the valuation model for ease of calculation.

The calculated net present value from the valuation model forms the basis for pricing the certificates associated with the virtual biological asset.

In step 140 that follows one or more redeemable certificates associated with the virtual biological asset are issued by the computer system 200. More particularly, a virtual biological asset certificate is printed by the server 210, or one of the work stations 220-n, and issued to the purchaser of the financial instrument in exchange for a consideration that is based upon the calculation undertaken in step 130.

Each redeemable virtual biological asset certificate so issued is identified with a unique identification number, and is recorded with its date of issue in the database 215 together with its redemption date or the calendar period at any time during which it may be presented back to the issuer for redemption; the contact details of the owner of the certificate; a description of the virtual biological asset that the certificate represents, and the biological growth model(s) and valuation model(s) associated with that virtual biological asset.

At any date after issue the value of the certificate may be determined in step 150 by the system 100. As in step 130 the determination of the value is typically initiated by an operator from one of the work stations 220-n.

The value of the certificate may be determined to facilitate a trade in which the current owner of the certificate offers to sell it to another investor for a consideration based on the value so determined. Should a certificate be traded by an owner at any time prior to its redemption the change of ownership is recorded against the certificate so traded in the database 215. The database 215 acts as a registry of all issued certificates and their current owners.

As each certificate is associated with a redemption date or a calendar period at any time during which it may be presented back to the issuer for redemption, when the certificate is presented for redemption on such a valid redemption date the issuer may redeem it at its value on that date as determined in this step 150.

In step 150 the value of the certificate is again determined from the volume estimate derived from the biological growth models, and the valuation model. In the present example, the one or more biological growth models associated with the virtual timberland are used to calculate the increase in yield that would have occurred in an equivalent real timberland of the same species in the same region operating on the same specified management regime and containing the same mix of areas by age class, over the time that has elapsed since the certificate was first issued. As in step 130 the valuation model is also updated with current forestry costs, wood prices and discount rates relevant to an equivalent real timberland of the same species grown in the same region, operating on the same specified management regime and containing the same mix of areas by age class. All of the necessary current costs, prices and discount rates applying to the equivalent real timberland are provided through industry bodies who may refer to industry averages.

Step 150 is different in part from step 130 because in step 150, in addition to the estimates of future costs the value of each certificate is also affected by past costs, which are the costs that the owner would have incurred over the period since the certificate was issued had the virtual biological asset been a real biological asset. Past costs in the same categories as the future costs used in step 130 are accumulated and compounded forward at the rates of interest that applied and for the periods that applied from the date of purchase of the certificate to the date of its present valuation, and are then deducted from the calculated present value of the certificate so as to fairly represent the holding costs of the real biological asset. The applicable historic costs and rates of interest are provided through industry bodies.

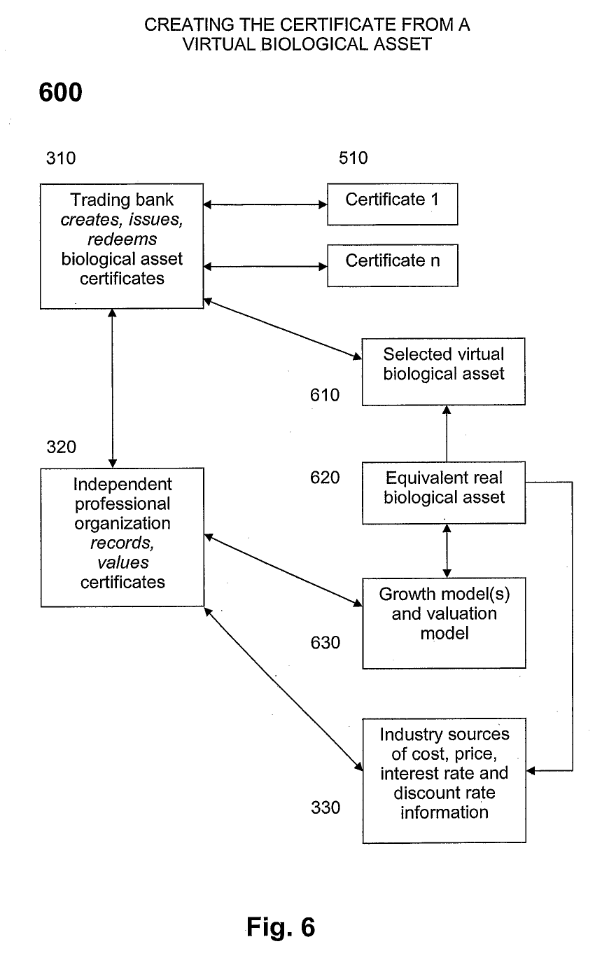

FIG. 6 shows a schematic block diagram of the relationships that could apply in the process of creating a typical biological asset certificate based upon a virtual biological asset such as a virtual timberland.

To commence the process 600 a trading bank 310 makes a selection of a virtual biological asset 610. Using one of the work stations 220-n in FIG. 2 it advises that selection over network 230 to an independent professional organisation 320.

The independent professional organisation 320 assigns one or more appropriate growth models 630 derived from the equivalent real biological asset 620 to the virtual biological asset 610 and determines the value of the virtual biological asset with reference to the growth models and information obtained from industry sources 330 on costs, prices, interest rates and discount rates applying to the equivalent real biological asset 620. The organisation 320 then advises the trading bank 310 of the value, using network 230.

On receipt of the value so determined the trading bank 310 creates one or more biological asset certificates 510 relating to the virtual biological asset 610 and priced in relation to the value advised by organisation 320.

Notional carbon sequestration may also be taken into account when determining the value of a certificate associated with a virtual timberland. The amount of carbon stored in a forest is directly related to the physical mass of the forest. Carbon sequestration in real timberland may therefore be measured by applying known conversion factors to the recoverable volumes estimated by forest growth models. The stored carbon will have a value directly related to the market value of carbon credits at the time. Accordingly notional stored carbon can be regarded and valued as part of the family of notional wood produce from a virtual timberland that includes timber, fuel wood and chip wood. The major difference is that carbon values will only be realised if the virtual forest is left standing while timber, fuel wood and chip wood values will only be realised if the virtual forest is harvested. Independent parties may be contracted to measure the carbon content of any given equivalent real timberland. Industry bodies can provide the known conversion factors and current market values of real carbon credits, allowing the issuer of the certificate to value the notional carbon content of the virtual timberland.

In the preferred implementation a major financial institution such as a trading bank creates the financial instrument, sells it to an investor, and redeems it again on a known future date. The instrument may be issued by the bank and sold as an unsecured financial instrument where the purchaser takes a credit risk on the bank itself.

For prudent commercial reasons it is preferred that the valuation of the instrument at the time of issue, at the time of redemption and at any intermediate time is done by an independent professional organisation with access to all of the necessary information including the biological growth models, valuation models, costs and market prices. That independent professional organisation is able to securely operate the information management system shown in FIG. 2 including network 230 and database 215. Preferably, issued certificates may be valued at any time from one of the work stations 220-n. Each work station may be operated by a certified agency of the trading bank and such an agency in addition to the independent professional organisation securely operating the information network behind the work station may charge a fee or brokerage on each valuation undertaken or on each interrogation of the database 215.

The trading bank would issue the instrument and investors would buy it in the expectation that the market value of the instrument as determined from time to time would be negatively or at least poorly correlated with that of the major financial asset classes of shares, treasury bills, and corporate or government bonds. That is, both the issuer and the purchaser of the instrument would expect it to generate a different rate of return from time to time from that of the consideration paid for it. The difference in the expectations of buyer and seller would be the basis for issuing and later trading the instrument.

In this example of a real or virtual timberland each certificate is assigned a maturity date on issue that is related to the optimal harvest date of an equivalent real timberland. The trading bank is able to monitor its financial exposure over time to the certificates that it has issued. By having fixed maturity dates or known redemption periods on the certificates, and consulting the independent professional organisation that has access to the relevant growth models, forest management costs and market prices for timber, fuel wood and chip wood, the trading bank is able to forecast from time to time the sums required to redeem those financial instruments as they fall due and to accrue and report on those changing liabilities.

Knowing the maturity dates for the certificates also allows the trading bank to arrange a natural hedge against the cost of redeeming a certificate at any time, if it believed that such a hedge would be prudent. A natural hedge could be provided by buying in advance a real biological asset of the same or similar type, size and maturity that could be liquidated as required to redeem the certificate.

Offering to redeem a certificate during a particular period rather than on a specific date would allow the trading bank to spread the cost of redeeming the certificates over time. It could also give the certificate holder some flexibility of timing, should market prices for the harvest produce of the real or virtual biological asset be rising or falling.

A certificate may also be traded on an electronic exchange as if it were share scrip, and any agency facilitating such a trade may also charge a brokerage for the transaction. Ownership of the certificate may be recorded on the database 215, thereby maintaining a register similar to a share register for the purposes of recording ownership, checking ownership and preventing fraud. Certificates are typically removed from the database 215 as they are redeemed by the issuing bank(s), similar to cancelling scrip that has been brought back by the issuing company.

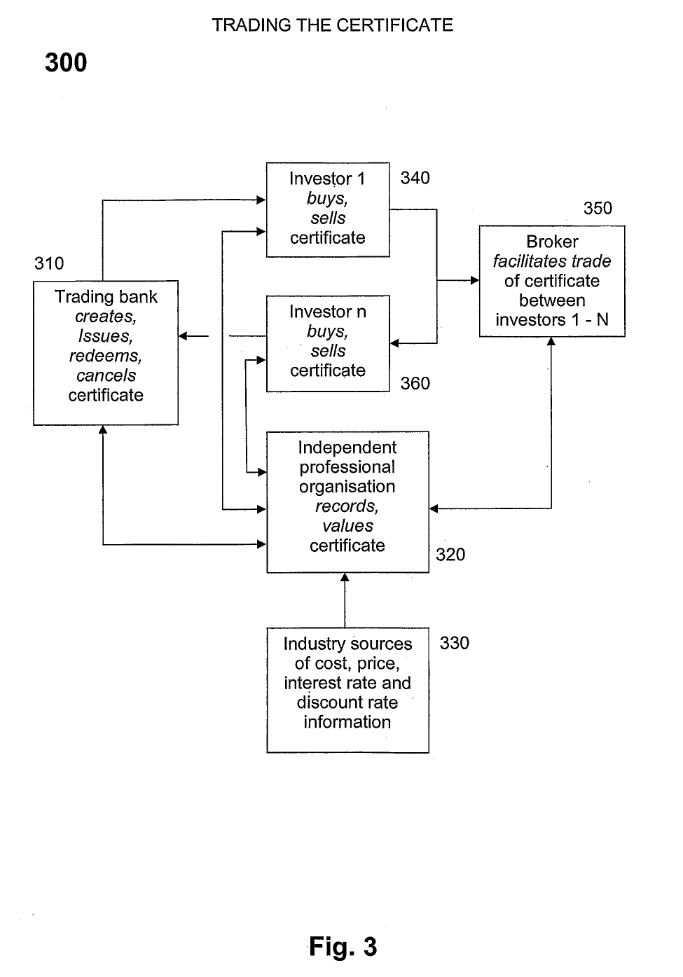

FIG. 3 shows a schematic block diagram of the relationships that could apply in the process 300 of creating, issuing, trading, redeeming and cancelling a typical biological asset certificate. The relationships commence with a trading bank 310 which starts with step 110 of FIG. 1 by entering a selection of a real or virtual biological asset into a work station 220-n as in FIG. 2.

The trading bank's selection and the associated asset description is received over network 230 of FIG. 2 by the independent professional organisation 320, which assigns one or more growth models to the selected biological asset as in step 120.

That organisation 320 then retrieves from industry sources 330 the necessary cost and price information relevant to the selected biological asset (or relevant to an issued certificate if a valuation of that certificate is requested) and the growth models, and calculates the current value of the real or virtual biological asset or of the nominated certificate as applicable using the appropriate growth models and valuation model as in step 130. The independent professional organisation 320 then informs the trading bank 310 of the current value of the selected asset or of the nominated certificate as applicable.

On receipt of the current value of the selected asset, the trading bank determines the selling price and prepares the associated biological asset certificate. It then issues the certificate as in step 140 to Investor 1 in consideration of the selling price so determined, and confirms the issue to the independent professional organisation 320 which registers the newly issued certificate together with Investor 1 as the owner 340 on the database 215.

At some future date Investor 1 checks the current value of the certificate through an authorised agency of the trading bank 310. That agency uses any work station 220-n to specify the name of the owner 340 and the unique identification number of the already issued certificate to the independent professional organisation 320, which returns a value of the certificate as in step 150 after obtaining relevant up to date information from the industry sources 330.

If Investor 1 decides to sell the certificate prior to its date of redemption to any other investor 2-N he contacts a broker 350. The broker 350 checks the current value of the certificate through an authorised agency of the trading bank as in step 150. The broker 350 then arranges the sale of the certificate to Investor n who buys it from Investor 1 at a negotiated price with the broker 350 taking a fee or commission. The broker 350 confirms the sale to the independent professional organisation 320 who updates the new owner's details 360 against that certificate recorded in database 215.

On the redemption date, the then owner 360 of the certificate being Investor n submits the certificate to the trading bank 310 to be redeemed. The trading bank 310 determines the current value of the certificate as in step 150 and pays the redemption sum associated with that current value to Investor n. The trading bank 310 then advises the independent professional organisation 320 that the certificate in question has been redeemed and all information relating to that certificate is cancelled from database 215.

This process may operate for any number of certificates of any value issued by any number of trading banks.

The process described above may be varied by the trading bank paying instalments of value to the holder of the certificate at regular or irregular intervals prior to the date of redemption of the certificate. The payment of such instalments in advance would reduce the value of the certificate on redemption, which may have advantages to the trading bank, while the receipt of interim instalments during the life of the certificate may have advantages for the owner of the certificate. Such instalments could for example be in the nature of an interest rate on the initial purchase price of the certificate, or percentages of the calculated value from time to time of the certificate, or other sums as determined and offered by the trading bank or negotiated between the trading bank and the investor.

As an example of the first aspect of the present invention, where the financial instrument is based upon ownership of a real biological asset such as a timberland, the financial instrument may be used where a timber processor is attempting to secure a long term wood supply from a number of small independent forest owners who do not operate collectively. Each small forest will generally contain a different mix of areas by age class from every other small forest, and each forest owner will generally have a different timetable from every other forest owner for harvesting and marketing his or her forest. A timber processor may find it difficult to reconcile the different timetables across the group of forest owners and negotiate terms of purchase in a way that allows him to regularly harvest a wood supply of a consistent age, size and quality for his processing plant.

This problem may be solved by separating the physical timber in the small forests from the owners' investments in the small forests. By replacing the small forests with biological asset certificates the owners' investments in timberlands may remain in place for their planned terms, while the wood in each timberland may be harvested according to the timetable of the wood processor.

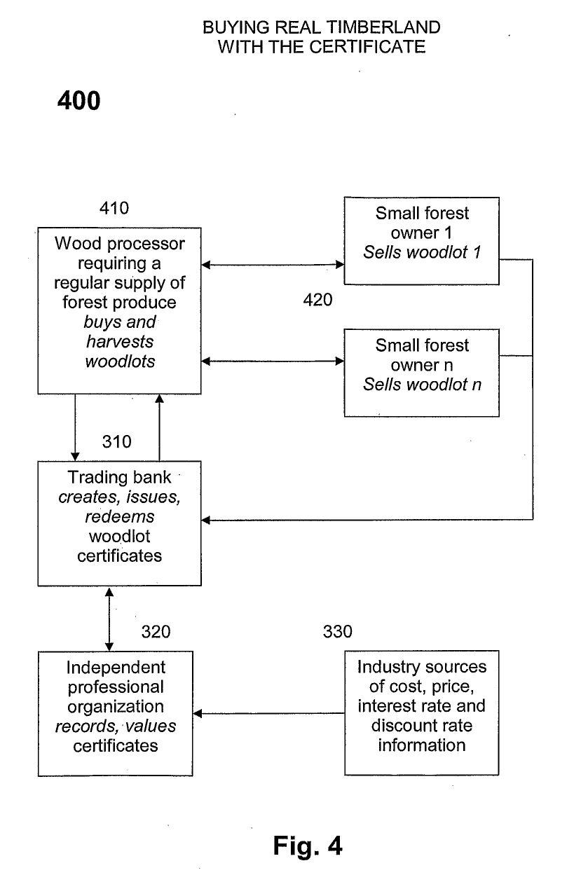

FIG. 4 shows a schematic block diagram of the commercial relationships that could apply in process 400 of applying the biological asset certificate to the problem of small forest harvesting and marketing.

In the first step a wood processor 410 requiring a regular and consistent supply of wood approaches a group 420 of small forest owners 1-N, who own forests that are at or near harvestable age. The wood processor 410 obtains from each forest owner 1-N details of their forests in terms of tree species, location, the mix of area by age class and the forest management regime of each small forest.

The wood processor 410 then approaches a trading bank 310, provides it with the forest information obtained from the forest owners 420, and requests the bank 310 to issue him with one biological asset certificate respectively for each of the small forests so described. The trading bank 310 creates and issues the 1-N certificates to the wood processor 410 at prices determined from the values calculated by the independent professional organisation 320 as in step 150 of FIG. 1, using the forest descriptions provided by the group 420 of small forest owners 1-N, together with the applicable growth and valuation models and the necessary industry information provided by industry sources 330.

The wood processor 410 returns to the group 420 of small forest owners 1-N and purchases from all or a sub-set of group 420 the harvesting rights of their forests, providing as consideration the respective biological asset certificates obtained from the trading bank 310.

On buying the harvesting rights, the wood processor 410 is free to manage the small forests concerned in such a way as to ensure a regular and consistent supply of wood to his processing plant.

Each small forest owner of the group 420 who sells the harvesting rights to his or her forest receives as payment a biological asset certificate that is based upon and that performs as an investment, just as if it were the individual forest that he or she originally owned. Each is then free to manage that investment on the same timetable that applied before he or she sold the harvesting rights. When any small forest owner wants the harvest revenue from the investment he or she redeems the certificate with trading bank 310.

Aspects of the present invention have been described by way of example only and it should be appreciated that modifications and additions may be made thereto without departing from the scope thereof. For example, the embodiments are described with reference to real and virtual timberlands. However, the invention is not so limited and the invention may be applied to other forms of real or virtual biological assets.

Further, the instrument has been described as a certificate relating to a single biological asset. Each certificate could however embody a portfolio of any number of assets and in particular, any number of virtual and/or real biological assets with or without different redemption dates allowing parts of the certificate to be redeemed at different times.

The word “certificate” has been used to describe the physical representation of the instrument but any other representation of the instrument can be used including an electronic representation as long as the chosen representation provides conclusive evidence of the investment and of the obligations of the parties to the investment.

Aspects of the present invention have been described by way of example only and it should be appreciated that modifications and additions may be made thereto without departing from the scope thereof as defined in the appended claims.

1. A central processing station for creating a financial instrument, wherein the central processing station is configured to operate in accordance with the following steps:
a) selecting a real biological asset;
b) assigning one or more biological growth models to that real biological asset;
c) determining a current value for the real biological asset;
d) issuing, based upon said current value one or more redeemable certificates associated with the real biological asset; and
e) determining at any point in the future new current values of the certificate using the growth model.

2. A central processing station for creating a financial instrument, wherein the central processing station is configured to operate in accordance with the following steps:
a) selecting a virtual biological asset whose key characteristics are based upon those that would be present in an equivalent real biological asset;
b) assigning one or more biological growth models that would apply to the equivalent real biological asset to the virtual biological asset;
c) determining a current value for the virtual biological asset using the growth model;
d) issuing, based upon said current value, one or more redeemable certificates associated with said virtual biological assets; and
e) determining at any point in the future new current values of said certificates using the growth model.

3. A method of creating a financial instrument using a central processing station as claimed in claim 1 which uses the growth models with reference to the cost of managing the real biological asset.

4. A method as claimed in claim 3 wherein the growth model is used with reference to the market prices currently prevailing for the harvestable produce of the real biological asset.

5. A method as claimed in claim 3 wherein the certificate has a redemption date.

6. A method as claimed in claim 3 wherein the certificate has a unique identifier.

7. A set of computer executable instructions for implementing the method as claimed in claim 3.

8. A central processor containing computer executable instructions as claimed in claim 7.

9. (canceled)

10. (canceled)

11. (canceled)

12. (canceled)

13. A method as claimed in claim 4 wherein the certificate has a redemption date.

14. A method as claimed in claim 4 wherein the certificate has a unique identifier.

15. A method as claimed in claim 5, wherein the certificate has a unique identifier.

16. A method of creating a financial instrument using a central processing station as claimed in claim 2 which uses the growth models with reference to the cost of managing the real biological asset.

17. A method as claimed in claim 16 wherein the growth model is used with reference to the market prices currently prevailing for the harvestable produce of the real biological asset.

18. A method as claimed in claim 16 wherein the certificate has a redemption date.

19. A method as claimed in claim 16 wherein the certificate has a unique identifier.

20. A method as claimed in claim 17 wherein the certificate has a redemption date.

21. A method as claimed in claim 17 wherein the certificate has a unique identifier.

22. A method as claimed in claim 18 wherein the certificate has a unique identifier.

23. A set of computer executable instructions for implementing the method as claimed in claim 14.

24. A central processor containing computer executable instructions as claimed in claim 17.
